(19) United States
(12) Patent Application Publication
(10) Pub. No.: US 2012/0037729 A1
(43) Pub. Date: Feb. 16, 2012

(54) Insertion Type Fluid Volume Meter and Control System

(76) Inventors: Joseph C. LEE, Riverside, CA (US); Timothy LEE, Irvine, CA (US)

(21) Appl. No.: 12/857,348

(22) Filed: Aug. 16, 2010

(51) Int. Cl. B05B 1/30; F16K 13/00

(52) U.S. Cl. 239/569; 137/455

(57) ABSTRACT

An insertion type fluid volume meter and control system comprises a non-ferrous pipe, an electromagnet device, a pair of electrodes, a flow control valve, and a flow controller. The electromagnet device is for building up a pulsed square wave magnetic field across the conductive liquid flowing through the non-ferrous pipe. The pair of electrodes are disposed on outer surface of the non-ferrous pipe for detecting an electromotive force induced by Faraday's induction law. The flow control valve is disposed in the non-ferrous pipe for controlling amount of flow. The flow controller is configured to receive output signal consisting of the induced electromotive force from the pair of electrodes and control the flow control valve base on the measured flow amount.

### BACKGROUND OF THE INVENTION

The present invention relates to an insertion type fluid volume meter and control system. More particularly, this invention relates to an insertion type fluid volume meter and control system, which can be applied easily to the conventional sprinkler systems.

The conventional sprinkler systems have their own time-based controllers. However, those conventional controllers are prone to malfunction and waste large quantity of water in some circumstances.

The vast area of the lawn-covered surface in the country makes it desperate to come up with a fundamental solutions to those kinds of problems of the conventional sprinkler or their controllers.

Accordingly, a need for an insertion type fluid volume meter and control system has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide an insertion type fluid volume meter and control system.

Another object of the invention is to provide an insertion type fluid volume meter and control system, which provides a mechanical moving part free device.

Still another object of the invention is to provide an a mechanical moving part free device, which controls the amount of flow in various ways.

An aspect of the invention provides an insertion type fluid volume meter and control system.

The insertion type fluid volume meter and control system comprises a non-ferrous pipe, an electromagnet device, a pair of electrodes, a flow control valve, and a flow controller.

The non-ferrous pipe is for flowing conductive liquid in a first direction therethrough.

The electromagnet device is for building up a pulsed square wave magnetic field in a second direction across the conductive liquid flowing through the non-ferrous pipe, and the first direction is perpendicular to the second direction.

The pair of electrodes are disposed on outer surface of the non-ferrous pipe for detecting an electromotive force induced in a third direction by Faraday's induction law, and the third direction is perpendicular to the first and second directions.

The flow control valve is disposed in the non-ferrous pipe for controlling amount of flow.

The flow controller is configured to receive output signal consisting of the induced electromotive force from the pair of electrodes and control the flow control valve.

The electromagnet device may comprise a magnetic core enclosing a part of the non-ferrous pipe, comprising a north pole and a south pole, a coil wound around a part of the magnetic core, and a power supply configured to supply a pulsed DC power to the coil.

The magnetic core may comprise a laminated magnetic core.

The pulsed DC power from the power supply may have a predetermined frequency.

The magnetic core may have a horse-shoe-shape, such that the magnetic core is configured to be installed around the non-ferrous pipe, and the north and south poles may be disposed in locations opposite to each other with the non-ferrous pipe in the middle.

The pulsed square wave magnetic field may be built between the north and south poles of the electromagnet device.

Each of the pair of electrodes may comprise a lead wire for outputting induced the electromotive force to the flow controller.

The lead wires from the pair of electrodes may be aligned parallel with the magnetic field by the electromagnet device.

The flow control valve may comprise a spring loaded shutdown valve.

The flow control valve may comprise a solenoid valve and a valve position switch.

The valve position switch may be configured to output a status of the flow control valve.

The electromagnet device may comprise a magnetic core, a coil, and power supply.

The magnetic core may be disposed on one side of the non-ferrous pipe, comprising a north pole and a south pole.

The coil may be wound around at least a part of the magnetic core.

The power supply may be configured to supply a pulsed DC power to the coil.

The north and south poles may be aligned along the second direction so as to build the magnetic field substantially along the second direction.

The electromagnet device may be configured to generate the pulsed square wave magnetic field with a frequency from about 20 Hz to about 30 Hz.

The flow controller may comprise a flow volume meter and a solenoid driver.

The flow volume meter may be for measuring flow volume for a given time period using the output signal including the induced electromotive force from the pair of electrodes.

The solenoid driver may be configured to control a solenoid of the flow control valve using signal from the fluid volume meter.

The flow controller may comprise a DC magnetic field generator for supplying the DC pulsed power of variable frequency to the electromagnet device for generating the pulsed square wave magnetic field.

The flow controller may further comprise a microprocessor for monitoring the output signal from the pair of electrodes and controlling the solenoid driver so as to stop the flow in case of malfunction of pre-existing time-based flow systems.

In other embodiment of the invention, a volume-based sprinkler system comprises a plurality of flow volume sensors, a plurality of flow control valves, and a flow controller.

Each of the plurality of flow volume sensors may comprise a non-ferrous pipe, an electromagnet device, and a pair of electrodes.

The non-ferrous pipe is flowing conductive liquid in a first direction therethrough.

The electromagnet device is for building up a pulsed square wave magnetic field in a second direction across the conductive liquid flowing through the non-ferrous pipe, and the first direction is perpendicular to the second direction.

The pair of electrodes are disposed on outer surface of the non-ferrous pipe for detecting an electromotive force induced in a third direction by Faraday's induction law, and the third direction is perpendicular to the first and second directions.

Each of the plurality of flow control valves is disposed downstream of the flow volume sensors in the corresponding non-ferrous pipe for controlling amount of flow.

The flow controller is configured to receive output signal consisting of the induced electromotive force from the pair of electrodes of the flow volume sensors and control the flow control valves individually based on time period or rate of the flow.

Each of the plurality of the non-ferrous pipes is configured to supply the fluid to a corresponding individual zone of the sprinkler system.

Each of the flow control valves may comprise a spring loaded shutdown valve, and the spring loaded shutdown valve may comprise a solenoid and a valve position switch.

The flow controller may comprise a flow volume meter, a solenoid driver, a DC magnetic field generator, and a microprocessor.

The flow volume meter is for measuring flow volume for a given time period using the output signal including the induced electromotive force from the pair of electrodes.

The solenoid driver is configured to control the solenoid of the flow control valve using signal from the fluid volume meter.

The DC magnetic field generator is for supplying the DC pulsed power of variable frequency to the electromagnet device for generating the pulsed square wave magnetic field.

The microprocessor is for monitoring and controlling the flow volume meter and the solenoid driver.

The solenoid driver may be configured to a relay between a regular sprinkler valve and a time-based sprinkler control for connecting or disconnecting the time-based sprinkler control from the regular sprinkler valve.

The advantages of the present invention are: (1) the insertion type fluid volume meter and control system provides an easy system to monitor and control the amount of fluid; and (2) the insertion type fluid volume meter and control system provides a mechanical moving part free device.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a flow volume sensor according to an embodiment of the present invention;

FIG. 2 is a perspective side view showing the flow volume sensor in FIG. 1;

FIG. 3 is a perspective front view the flow volume sensor in FIG. 1;

FIG. 4 is a perspective side view showing magnetic field applied to a flow volume sensor according to another embodiment of the present invention;

FIG. 5 is a perspective front view showing the magnetic field applied to the flow volume sensor in FIG. 4;

FIG. 6 is a schematic diagram showing a volume-based sprinkler system according to still another embodiment of the present invention; and

FIG. 7 is a schematic diagram showing a volume-based sprinkler system with a single sprinkler valve of FIG. 6.

### DETAILED DESCRIPTION EMBODIMENTS OF THE INVENTION

One of the objects of the invention is to provide an insertion type fluid volume meter and control system, which controls the amount of flow in various ways.

In a normal or standard existing conventional sprinkler system, the central unit controls the flow of the liquid (usually water) based on the time duration selected through a (sprinkler) control panel.

The invention comprises a liquid volume measurement & control System. More specifically, the system comprises: flow volume sensor; flow shutdown valve; and time based flow valve.

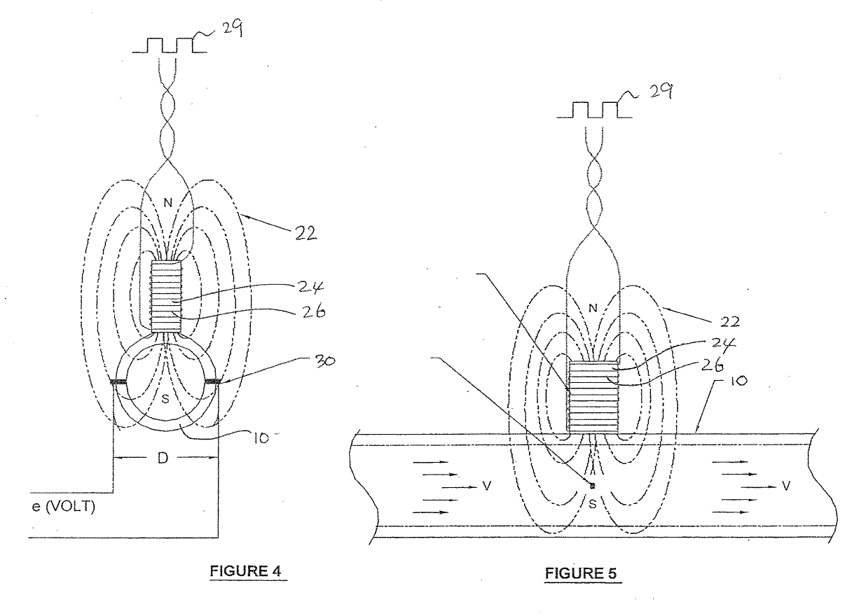

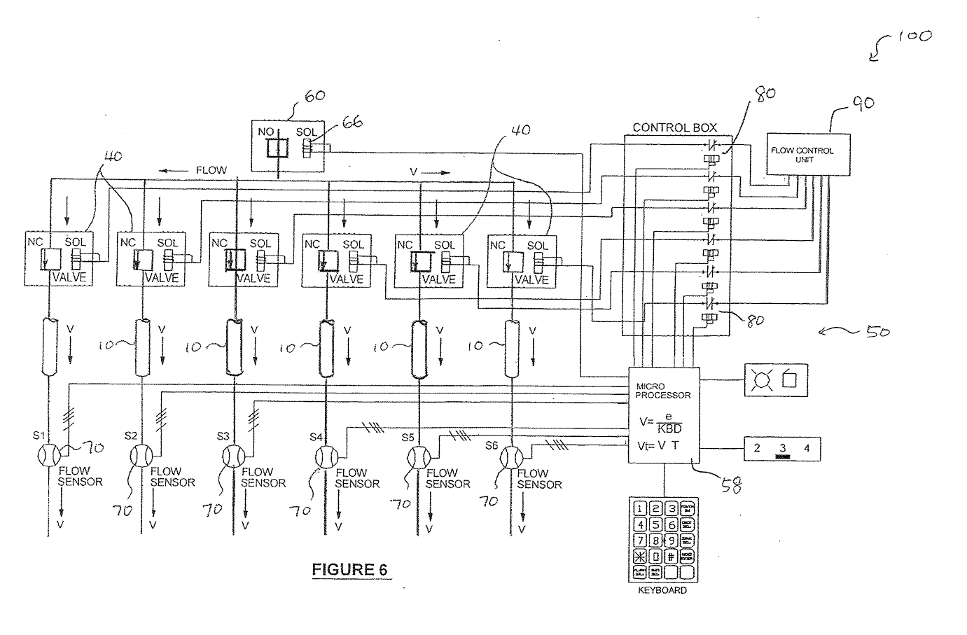

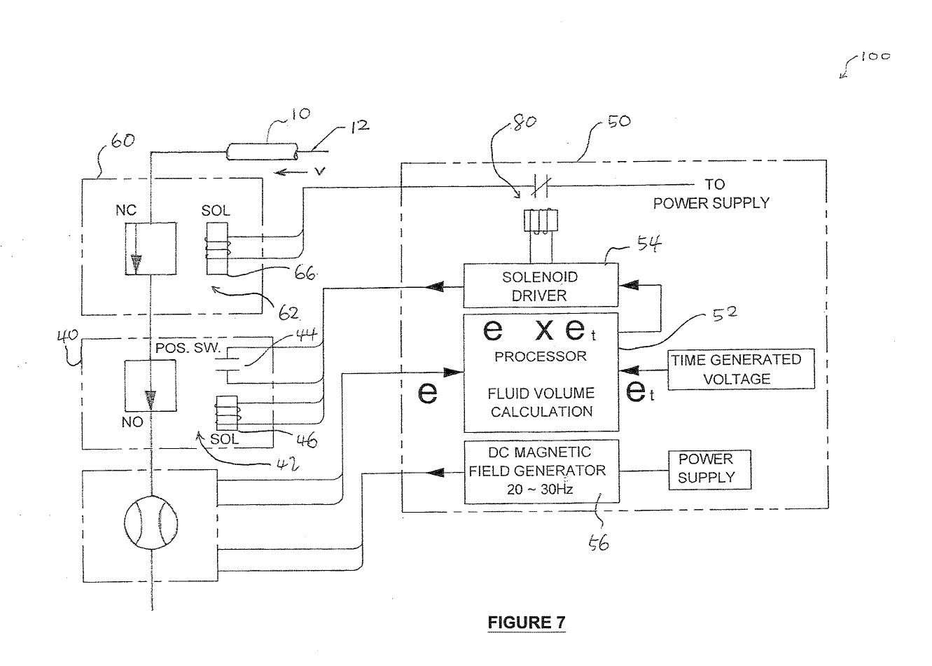

FIGS. 1-3 show an insertion type fluid volume meter according to an embodiment of the present invention. FIGS. 4-5 show an insertion type fluid volume meter according to another embodiment of the invention. FIGS. 6 and 7 show an insertion type fluid volume meter 100 according to an embodiment of the present invention.

An aspect of the invention provides the insertion type fluid volume meter and control system 100.

The insertion type fluid volume meter and control system 100 comprises a non-ferrous pipe 10, an electromagnet device 20, a pair of electrodes 30, a flow control valve 40, and a flow controller 50.

The non-ferrous pipe 10 is for flowing conductive liquid 12 in a first direction therethrough.

The electromagnet device 20 is for building up a pulsed square wave magnetic field 22 in a second direction across the conductive liquid flowing through the non-ferrous pipe 10, and the first direction is perpendicular to the second direction as shown in FIGS. 1-3.

The pair of electrodes 30 are disposed on outer surface of the non-ferrous pipe 10 for detecting an electromotive force induced in a third direction by Faraday's induction law, and the third direction is perpendicular to the first and second directions.

The flow control valve 40 is disposed in the non-ferrous pipe 10 for controlling amount of flow.

The flow controller 50 is configured to receive output signal consisting of the induced electromotive force (e) from the pair of electrodes 30 and control the flow control valve 40 as shown in FIG. 7.

The electromagnet device 20 may comprise a magnetic core 24 enclosing a part of the non-ferrous pipe 10, comprising a north pole and a south pole, a coil 26 wound around a part of the magnetic core 24, and a power supply (not shown) configured to supply a pulsed DC power 29 to the coil.

The magnetic core 24 may comprise a laminated magnetic core.

The pulsed DC power 29 from the power supply may have a predetermined frequency.

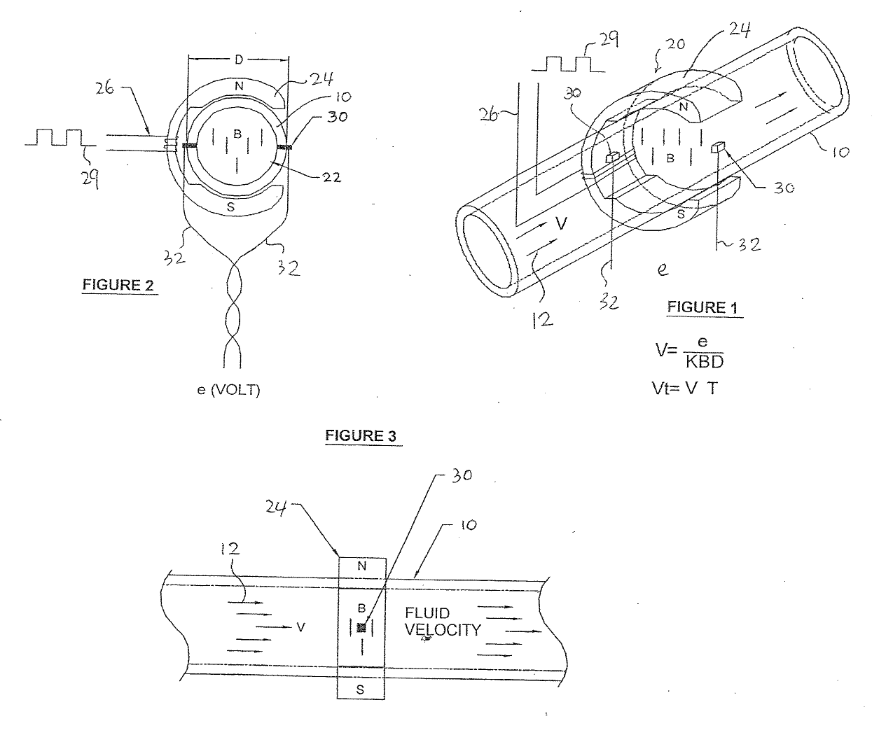

The magnetic core 24 may have a horse-shoe-shape as shown in FIGS. 1 and 2, such that the magnetic core 24 is configured to be installed around the non-ferrous pipe 10, and the north and south poles may be disposed in locations opposite to each other with the non-ferrous pipe 10 in the middle.

The pulsed square wave magnetic field 22 may be built between the north and south poles of the electromagnet device 20.

Each of the pair of electrodes 30 may comprise a lead wire 32 for outputting induced the electromotive force (e) to the flow controller 50.

The lead wires 32 from the pair of electrodes 30 may be aligned parallel with the magnetic field by the electromagnet device 20 as shown in FIGS. 1 and 2, such that the induced electromotive force (e) may not be interfered.

The flow control valve 40 may comprise a spring loaded shutdown valve as shown in FIG. 7.

The flow control valve 40 may comprise a solenoid valve 42 and a valve position switch 44 as shown in FIG. 7.

The valve position switch 44 may be configured to output a status of the flow control valve 40, which may be input to the flow controller 50 as shown in FIG. 7.

The electromagnet device 20 may comprise a magnetic core 24, a coil 26, and power supply as described in the above.

The magnetic core 24 may be disposed on one side of the non-ferrous pipe 10, comprising a north pole and a south pole as shown in FIGS. 4 and 5.

The coil 26 may be wound around at least a part of the magnetic core 24.

The power supply may be configured to supply a pulsed DC power 29 to the coil 26.

The north and south poles may be aligned along the second direction so as to build the magnetic field 22 substantially along the second direction.

In certain embodiments, the direction of the magnetic field 22 may not be substantially perpendicular to the flow. Even with such magnetic fields 22, the amount of flow can be calibrated with the electromotive force (e) and measured correctly.

The electromagnet device 20 may be configured to generate the pulsed square wave magnetic field 22 with a frequency from about 20 Hz to about 30 Hz.

The flow controller 50 may comprise a flow volume meter 52 and a solenoid driver 54.

The flow volume meter 52 may be for measuring flow volume for a given time period using the output signal including the induced electromotive force (e) from the pair of electrodes 30.

The solenoid driver 54 may be configured to control a solenoid 46 of the flow control valve 40 using signal from the fluid volume meter 52.

The flow controller 50 may comprise a DC magnetic field generator 56 for supplying the DC pulsed power 29 of variable frequency to the electromagnet device 20 for generating the pulsed square wave magnetic field 22.

The flow controller 50 may further comprise a microprocessor 58 for monitoring the output signal from the pair of electrodes 30 and controlling the solenoid driver 54 so as to stop the flow in case of malfunction of pre-existing time-based flow systems 60 comprising a solenoid valve 62 and a solenoid 66 as shown in FIG. 7.

In other embodiment of the invention shown in FIG. 6, a volume-based sprinkler system 100 comprises a plurality of flow volume sensors 70, a plurality of flow control valves 40, and a flow controller 50.

Each of the plurality of flow volume sensors 70 may comprise a non-ferrous pipe 10, an electromagnet device 20, and a pair of electrodes 30.

The non-ferrous pipe 10 is flowing conductive liquid in a first direction therethrough.

The electromagnet device 20 is for building up a pulsed square wave magnetic field in a second direction across the conductive liquid flowing through the non-ferrous pipe 10, and the first direction is perpendicular to the second direction.

The pair of electrodes 30 are disposed on outer surface of the non-ferrous pipe 10 for detecting an electromotive force induced in a third direction by Faraday's induction law, and the third direction is perpendicular to the first and second directions.

Each of the plurality of flow control valves 40 is disposed downstream of the flow volume sensors 70 in the corresponding non-ferrous pipe 10 for controlling amount of flow as shown in FIG. 7.

Alternatively, each of the plurality of flow control valves 40 is disposed upstream of the flow volume sensors 70 in the corresponding non-ferrous pipe 10 as shown in FIG. 6.

The flow controller 50 is configured to receive output signal consisting of the induced electromotive force from the pair of electrodes 30 of the flow volume sensors 70 and control the flow control valves 40 individually based on time period or rate of the flow. Still the controlling may be performed based on volume of the flow.

Each of the plurality of the non-ferrous pipes 10 is configured to supply the fluid to a corresponding individual zone of the sprinkler systems (not shown) which are connected downstream to the flow sensors 70 as shown in FIG. 6.

Each of the flow control valves 40 may comprise a spring loaded shutdown valve, and the spring loaded shutdown valve may comprise a solenoid 46 and a valve position switch 44 as in FIG. 7.

The flow controller 50 may comprise a flow volume meter 52, a solenoid driver 54, a DC magnetic field generator 56, and a microprocessor as in FIGS. 6 and 7.

The flow volume meter 52 is for measuring flow volume for a given time period using the output signal including the induced electromotive force from the pair of electrodes.

The solenoid driver 54 is configured to control the solenoid of the flow control valve 40 using signal from the fluid volume meter.

The DC magnetic field generator 56 is for supplying the DC pulsed power of variable frequency to the electromagnet device 20 for generating the pulsed square wave magnetic field.

The microprocessor 58 is for monitoring and controlling the flow volume meter 52 and the solenoid driver 54.

The solenoid driver 54 may be configured to a relay 80 between a regular sprinkler valve 60 and a time-based sprinkler control for connecting or disconnecting the time-based sprinkler control from the regular sprinkler valve 60.

In certain embodiments of the invention, the volume of the fluid must be calculated with the following Faraday's equation:

Volume=Time×e/B×D,

where

e=Voltage between two electrodes (see FIG. 1, 2, 3)

B=Magnetic field

D=Distance between two electrodes,

and the voltage may be in volts and the magnetic field may be in gauss.

When pre-selected amount of fluid is detected (see FIG. 7 revised) the control unit will shutdown sprinkler valve #2 even if timer of the sprinkler's controller (not shown in FIG. 7) is not expired.

If valve #2 does not respond due to its malfunction, the controller will shut down the valve #1 upon reaching pre-determined volume of fluid and time delay.

When shutdown Valve #1 is activated or shutdown the position switch will energize audible and visible alarm until valve #1 is manually reset.

The magnitude of the error signal is a function of the number of turns in the loop, and the change in magnetic flux per unit time. In a magnetic flow-sensor, the electrode wires and the path through the conductive liquid between the electrodes represent a single turn loop. The flow-dependent voltage is in phase with the changing magnetic field; however, flow-independent voltage is also generated, which is 90 degrees out of phase with the changing magnetic field.

The flow-independent voltage is therefore an error voltage which is 90 degrees out of phase with the desired signal. This error voltage is often referred to as quadrature. In order to minimize the amount of quadrature generated, the electrode wires must be arranged so that they are parallel with the lines of flux of the magnetic field.

In ac field magmeters, because the magnetic field alternates continuously at line frequency, quadrature is significant. It is necessary to employ phase-sensitive circuitry to detect and reject quadrature.

It is this circuitry which makes the ac magnetic meter highly sensitive to the coating on the electrodes. Since coatings cause a phase shift in the voltage signal, phase-sensitive circuitry leads to rejection of the true voltage flow signal, thus leading to error.

Since dc pulse magmeters are not sensitive to phase shift and require no phase-sensitive circuitry, coatings on the electrode have a very limited effect on flow-sensor performance.

In ac magnetic flow-sensor, the signal generated by flow through the sensor is at line frequency. This makes these sensors susceptible to noise pickup from any ac lines. Therefore, complicated wiring systems are typically required to isolate the ac sensor signal lines from both its own and from any other nearby power lines, in order to preserve signal integrity.

In comparison, DC pulse magmeters have a pulse frequency much lower (typically 5 to 10% of ac line frequency) than ac meters. This lower frequency eliminates noise pickup from nearby ac lines, allowing power and signal lines to be run in the same conduit and thus simplifying wiring. Wiring is further simplified by the use of integral signal conditioners to provide voltage and current outputs. No separate wiring to the signal conditioners is required.

Some magnetic sensor employ alternating current to excite the magnetic field coils which generate the magnetic field of the flow-sensor (ac magnetic flow-sensor). As a result, the direction of the magnetic field alternates at line frequency, i.e., 50 to 60 times per second. If a loop of conductive wire is located in a magnetic field, a voltage will be generated in that loop of wire. From physics, we can determine that this voltage is 90 degrees out of phase with respect to the primary magnetic field.

In FIG. 7, NO stands for ‘normally open’, NC for ‘normally closed valve’, SOL for ‘solenoid (electrically operated) valve’, POS for ‘valve position switch’, and SW for switch.

In certain embodiment of the invention, the time may be measured as a voltage, eₜ as in FIG. 7, and supplied to the flow volume meter 52.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An insertion type fluid volume meter and control system comprising:
a non-ferrous pipe flowing conductive liquid in a first direction therethrough;
an electromagnet device for building up a pulsed square wave magnetic field in a second direction across the conductive liquid flowing through the non-ferrous pipe, wherein the first direction is perpendicular to the second direction;
a pair of electrodes disposed on outer surface of the non-ferrous pipe for detecting an electromotive force induced in a third direction by Faraday's induction law, wherein the third direction is perpendicular to the first and second directions;
a flow control valve disposed in the non-ferrous pipe for controlling amount of flow; and
a flow controller configured to receive output signal consisting of the induced electromotive force from the pair of electrodes and control the flow control valve.

2. The insertion type fluid volume meter and control system of claim 1, wherein the electromagnet device comprises:
a magnetic core enclosing a part of the non-ferrous pipe, comprising a north pole and a south pole;
a coil wound around a part of the magnetic core; and
a power supply configured to supply a pulsed DC power to the coil.

3. The insertion type fluid volume meter and control system of claim 2, wherein the magnetic core comprises a laminated magnetic core.

4. The insertion type fluid volume meter and control system of, claim 2, wherein the pulsed DC power from the power supply has a predetermined frequency.

5. The insertion type fluid volume meter and control system of claim 2, wherein the magnetic core has a horse-shoe-shape, such that the magnetic core is configured to be installed around the non-ferrous pipe, wherein the north and south poles are disposed in locations opposite to each other with the non-ferrous pipe in the middle.

6. The insertion type fluid volume meter and control system of claim 2, wherein the pulsed square wave magnetic field is built between the north and south poles of the electromagnet device.

7. The insertion type fluid volume meter and control system of claim 1, wherein each of the pair of electrodes comprises a lead wire for outputting induced the electromotive force to the flow controller.

8. The insertion type fluid volume meter and control system of claim 7, wherein the lead wires from the pair of electrodes are aligned parallel with the magnetic field by the electromagnet device.

9. The insertion type fluid volume meter and control system of claim 1, wherein the flow control valve comprises a spring loaded shutdown valve.

10. The insertion type fluid volume meter and control system of claim 9, wherein the flow control valve comprises a solenoid valve and a valve position switch.

11. The insertion type fluid volume meter and control system of claim 10, wherein the valve position switch is configured to output a status of the flow control valve.

12. The insertion type fluid volume meter and control system of claim 1, wherein the electromagnet device comprises:
a magnetic core disposed on one side of the non-ferrous pipe, comprising a north pole and a south pole;
a coil wound around at least a part of the magnetic core; and
a power supply configured to supply a pulsed DC power to the coil,
wherein the north and south poles are aligned along the second direction so as to build the magnetic field substantially along the second direction.

13. The insertion type fluid volume meter and control system of claim 1, wherein the electromagnet device is configured to generate the pulsed square wave magnetic field with a frequency from about 20 Hz to about 30 Hz.

14. The insertion type fluid volume meter and control system of claim 1, wherein the flow controller comprises:
a flow volume meter for measuring flow volume for a given time period using the output signal including the induced electromotive force from the pair of electrodes; and
a solenoid driver configured to control a solenoid of the flow control valve using signal from the fluid volume meter.

15. The insertion type fluid volume meter and control system of claim 14, wherein the flow controller comprises a DC magnetic field generator for supplying the DC pulsed power of variable frequency to the electromagnet device for generating the pulsed square wave magnetic field.

16. The insertion type fluid volume meter and control system of claim 14, wherein the flow controller further comprises a microprocessor for monitoring the output signal from the pair of electrodes and controlling the solenoid driver so as to stop the flow in case of malfunction of pre-existing time-based flow systems.

17. A volume-based sprinkler system comprising:
a plurality of flow volume sensors, each of which comprising:
a non-ferrous pipe flowing conductive liquid in a first direction therethrough;
an electromagnet device for building up a pulsed square wave magnetic field in a second direction across the conductive liquid flowing through the non-ferrous pipe, wherein the first direction is perpendicular to the second direction; and
a pair of electrodes disposed on outer surface of the non-ferrous pipe for detecting an electromotive force induced in a third direction by Faraday's induction law, wherein the third direction is perpendicular to the first and second directions;
a plurality of flow control valves, each being disposed downstream of the flow volume sensors in the corresponding non-ferrous pipe for controlling amount of flow; and
a flow controller configured to receive output signal consisting of the induced electromotive force from the pair of electrodes of the flow volume sensors and control the flow control valves individually based on time period or rate of the flow,
wherein each of the plurality of the non-ferrous pipes is configured to supply the fluid to a corresponding individual zone of the sprinkler system.

18. The volume-based sprinkler system of claim 17, wherein each of the flow control valves comprises a spring loaded shutdown valve, and wherein the spring loaded shutdown valve comprises a solenoid and a valve position switch.

19. The volume-based sprinkler system of claim 18, wherein the flow controller comprises:
a flow volume meter for measuring flow volume for a given time period using the output signal including the induced electromotive force from the pair of electrodes;
a solenoid driver configured to control the solenoid of the flow control valve using signal from the fluid volume meter;
a DC magnetic field generator for supplying the DC pulsed power of variable frequency to the electromagnet device for generating the pulsed square wave magnetic field; and
a microprocessor for monitoring and controlling the flow volume meter and the solenoid driver.

20. The volume-based sprinkler system of claim 19, wherein the solenoid driver is configured to a relay between a regular sprinkler valve and a time-based sprinkler control for connecting or disconnecting the time-based sprinkler control from the regular sprinkler valve.
